(19) United States
(12) Patent Application Publication
(10) Pub. No.: US 2006/0047934 A1
(43) Pub. Date: Mar. 2, 2006

(54) Integrated circuit capable of memory access control

(76) Inventors: Mark A. Schmisseur, Phoenix, AZ (US); Joseph Murray, Scottsdale, AZ (US); Richard P. Mackey, Phoenix, AZ (US); Micheil J. Lee, Phoenix, AZ (US)

Correspondence Address: Grossman, Tucker, Perreault & Pfleger, PLLC;c/o Portfolio IP, P.O. Box 52050, Minneapolis, MN, 55402, US

(21) Appl. No.: 10/931,278

(22) Filed: Aug. 31, 2004

(51) Int. Cl. G06F 12/00

(52) U.S. Cl. 711/168

(57) ABSTRACT

A method according to one embodiment may include selecting a port, among a plurality of ports. The method of this embodiment may also include selecting between a memory read request and a memory write request from at least one port, among the plurality of ports, based on, at least in part, at least one memory access rule. Of course, many alternatives, variations, and modifications are possible without departing from this embodiment.

### FIELD

The present disclosure relates to an integrated circuit capable of memory access control.

### BACKGROUND

In one conventional integrated system, a plurality of components may generate data read and data write requests to memory. A memory controller may control data in and out of memory based on requests from components attempting access to memory. However, the conventional integrated system lacks the capability to provide memory access control for a multi-ported memory controller in which a plurality of peripherals attempt memory access through the memory controller. Also, the conventional system does not provide a set of rules to define memory access among a plurality of peripherals attempting access to memory. Therefore, the conventional system cannot provide coherent memory access in a multi-ported memory controller.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram illustrating an exemplary system embodiment;

FIG. 2 is diagram illustrating in more detail an integrated circuit of the embodiment of FIG. 1;

FIG. 3 is a diagram illustrating in more detail exemplary memory control circuitry of an integrated circuit of the embodiment of FIG. 1;

FIG. 4 is a flowchart illustrating exemplary operations that may be performed according to an embodiment; and

FIG. 5 is a flowchart illustrating exemplary operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

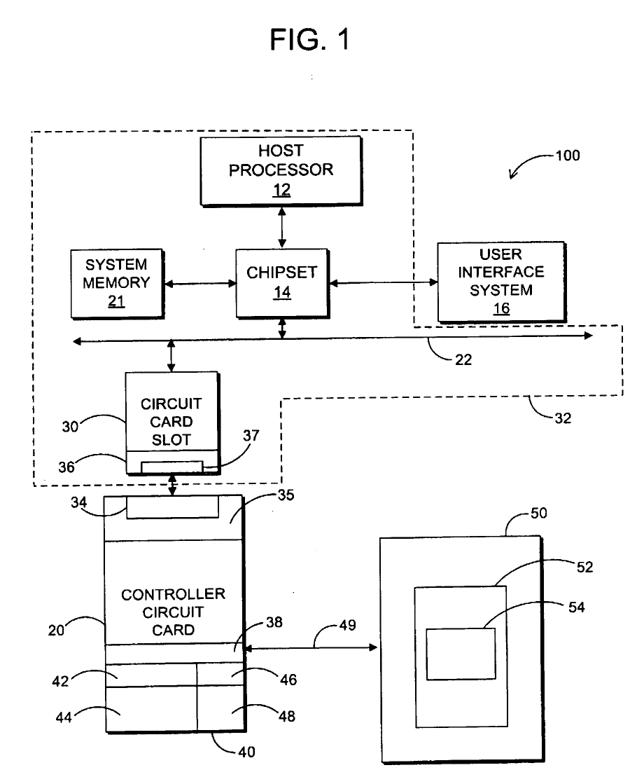

FIG. 1 illustrates a system embodiment 100 of the claimed subject matter. System 100 may include a host processor 12 coupled to a chipset 14. Host processor 12 may comprise, for example, an Intel® Pentium® IV microprocessor that is commercially available from the Assignee of the subject application. Of course, alternatively, host processor 12 may comprise another type of microprocessor, such as, for example, a microprocessor that is manufactured and/or commercially available from a source other than the Assignee of the subject application, without departing from this embodiment.

Chipset 14 may include a host bridge/hub system that may couple host processor 12, a system memory 21 and a user interface system 16 to each other and to a bus system 22. Chipset 14 may also include an input/output (I/O) bridge/hub system (not shown) that may couple the host bridge/bus system to bus 22. Chipset 14 may comprise integrated circuit chips, such as those selected from integrated circuit chipsets commercially available from the assignee of the subject application (e.g., graphics memory and I/O controller hub chipsets), although other integrated circuit chips may also, or alternatively be used, without departing from this embodiment. User interface system 16 may comprise, e.g., a keyboard, pointing device, and display system that may permit a human user to input commands to, and monitor the operation of, system 100.

Bus 22 may comprise a bus that complies with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). Alternatively, bus 22 instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also alternatively, bus 22 may comprise other types and configurations of bus systems, without departing from this embodiment.

Controller card 20 may be coupled to and control the operation of mass storage 50. In this embodiment, mass storage 50 may comprise, e.g., one or more redundant arrays of independent disks (RAID) 52. The RAID level that may be implemented by RAID 29 may be 0, 1, or greater than 1. RAID 52 may comprise, for example, one or more disk mass storage devices and/or one or more peripheral devices (collectively or singly shown in FIG. 1 by the block referred to by numeral 54).

Processor 12, system memory 21, chipset 14, bus 22, and circuit card slot 30 may be comprised in a single circuit board, such as, for example, a system motherboard 32. Mass storage 50 may be comprised in one or more respective enclosures that may be separate from the enclosure in which the motherboard 32 and the components comprised in the motherboard 32 are enclosed.

Storage array controller card 20 (hereinafter “controller card 20”) may be coupled to and control the operation of storage array 50. Controller card 20 may be coupled to one or more mass storage devices 54 comprised in storage array 50 via one or more network communication links 49. Depending at least in part upon the operating mode of an integrated circuit 40 that may be comprised in card 20, card 20 may exchange data and/or commands with mass storage devices 54, via links 49, using one or more of a variety of different communication protocols, e.g., Fibre Channel (FC), Serial Advanced Technology Attachment (SATA), and/or Serial Attached Small Computer Systems Interface (SAS) protocol. Of course, alternatively, controller card 20 may exchange data and/or commands with mass storage devices 54 using other and/or additional communication protocols, without departing from this embodiment.

In accordance with this embodiment, if a FC protocol is used by controller card 20 to exchange data and/or commands with mass storage 54, it may comply or be compatible with the interface/protocol described in ANSI Standard Fibre Channel (FC) Physical and Signaling Interface-3 X3.303:1998 Specification. Alternatively, if a SATA protocol is used by controller card 20 to exchange data and/or commands with mass storage 54, it may comply or be compatible with the protocol described in “Serial ATA: High Speed Serialized AT Attachment,” Revision 1.0, published on Aug. 29, 2001 by the Serial ATA Working Group. Further alternatively, if a SAS protocol is used by controller card 20 to exchange data and/or commands with mass storage 54, it may comply or be compatible with the protocol described in “Information Technology—Serial Attached SCSI (SAS),” Working Draft American National Standard of International Committee For Information Technology Standards (INCITS) T10 Technical Committee, Project T10/1562-D, Revision 2b, published 19 Oct. 2002, by American National Standards Institute (hereinafter termed the “SAS Standard”) and/or later-published versions of the SAS Standard.

Depending upon, for example, whether bus 22 comprises a PCI Express™ bus or a PCI-X bus, circuit card slot 20 may comprise, for example, a PCI Express™ or PCI-X bus compatible or compliant expansion slot or interface 36. Interface 36 may comprise a bus connector 37 may be electrically and mechanically mated with a mating bus connector 34 that may be comprised in a bus expansion slot or interface 35 in circuit card 20. Slot 30 and card 20 may be constructed to permit card 20 to be inserted into slot 30. When card 20 is properly inserted into slot 30, connectors 34 and 36 may become electrically and mechanically coupled to each other. When connectors 34 and 36 are so coupled to each other, card 20 becomes electrically coupled to bus 22 and may exchange data and/or commands with system memory 21, host processor 12, and/or user interface system 16 via bus 22 and chipset 14.

Circuit card 20 may comprise an integrated circuit 40, and computer-readable memory 38. As used herein, an “integrated circuit” means a semiconductor device and/or microelectronic device, such as, for example, a semiconductor integrated circuit chip. Memory 38 may comprise one or more of the following types of memories: semiconductor firmware memory, programmable memory, non-volatile memory, read only memory, electrically programmable memory, random access memory, flash memory, magnetic disk memory, and/or optical disk memory. Either additionally or alternatively, memory 38 may comprise other and/or later-developed types of computer-readable memory.

Machine-readable firmware program instructions may be stored in memory 38. As described below, these instructions may be accessed and executed by integrated circuit 40. When executed by integrated circuit 40, these instructions may result in integrated circuit 40 performing the operations described herein as being performed by integrated circuit 40.

Alternatively, without departing from this embodiment, the operative circuitry of card 20 may not be comprised in card 20, but instead, may be comprised in other structures, systems, and/or devices. These other structures, systems, and/or devices may be, for example, comprised in motherboard 32, coupled to bus 22, and exchange data and/or commands with other components (such as, for example, system memory 21, host processor 12, and/or user interface system 16) in system 100.

Integrated circuit may comprise processor circuitry 42, bus bridge circuitry 44, DMA (direct memory access) controller circuitry 46, and/or memory controller circuitry 48. Processor circuitry 42 may include processor core circuitry that may comprise a plurality of processor cores. As used herein, a “processor core” may comprise hardwired circuitry, programmable circuitry, and/or state machine circuitry. Also, as used herein, “circuitry” may comprise, for example, singly or in any combination, hardwired circuitry, programmable circuitry, state machine circuitry, and/or firmware that stores instructions executed by programmable circuitry. In this embodiment, processor 42 may comprise circuitry that may be compatible and/or in compliance with the Intel® XScale™ Core micro-architecture described in “Intel® XScale™ Core Developers Manual,” published December 2000 by the Assignee of the subject application. Of course, processor circuitry 42 may comprise other types of processor core circuitry without departing from this embodiment.

Bus bridge circuitry 44 may comprise respective interface circuitry that may be used to permit integrated circuit 40 to be able to exchange, in accordance with one of a plurality of different host bus protocols with which bus 22 may comply or be compatible, data and/or commands with other devices that may be coupled to bus 22. For example, in this embodiment, circuitry 44 may comprise PCI-X bus interface circuitry and/or PCI Express™ bus interface circuitry (not shown). That is, as discussed below, depending, at least in part, upon the bus protocol with which bus 22 may comply or be compatible, a particular operating mode of integrated circuit 40 may be selected in which only a single appropriate one of the respective interface circuitry in circuitry 44 may be enabled to exchange data and/or commands with devices that may be coupled to bus 22, other respective interface circuitry in circuitry 44 may be disabled.

Depending upon a selected mode of operation of integrated circuit 40, DMA controller circuitry 46 may control, based upon commands and/or data received by circuitry 46 from other circuitry in integrated circuit 40, the exchange of data and/or commands received or intended to be transmitted by integrated circuit 40 via one or more links 49. Without departing from this embodiment, DMA controller circuitry 46 may not be comprised in integrated circuit 40, but instead, may comprise circuitry that is distinct from integrated circuit 40, and is coupled to circuitry 48 via, for example, a bus.

Memory control circuitry 48 may control storage of data in, and retrieval of data from memory 38. For example, in this embodiment, memory control circuitry 48 may exchange commands and/or data with, for example, processor circuitry 42, bus bridge circuitry 44 and/or DMA controller circuitry 46. Based, at least in part, upon these commands, memory control circuitry 48 may exchange data and/or commands with memory 38. This may result in memory 38 storing and/or retrieving data in accordance with the commands and/or data supplied to memory controller circuitry 48. Of course, memory control circuitry 48 may exchange commands and/or data with other circuitry (not shown) comprised in integrated circuit 40 without departing from this embodiment. As will be described in greater detail below, memory controller 48 may be capable of controlling, at least in part, access to memory 38 (for example, memory read and/or write commands) from one or more of processor 42, DMA controller 46 and/or bus bridge 44, based on, for example, at least one memory access rule.

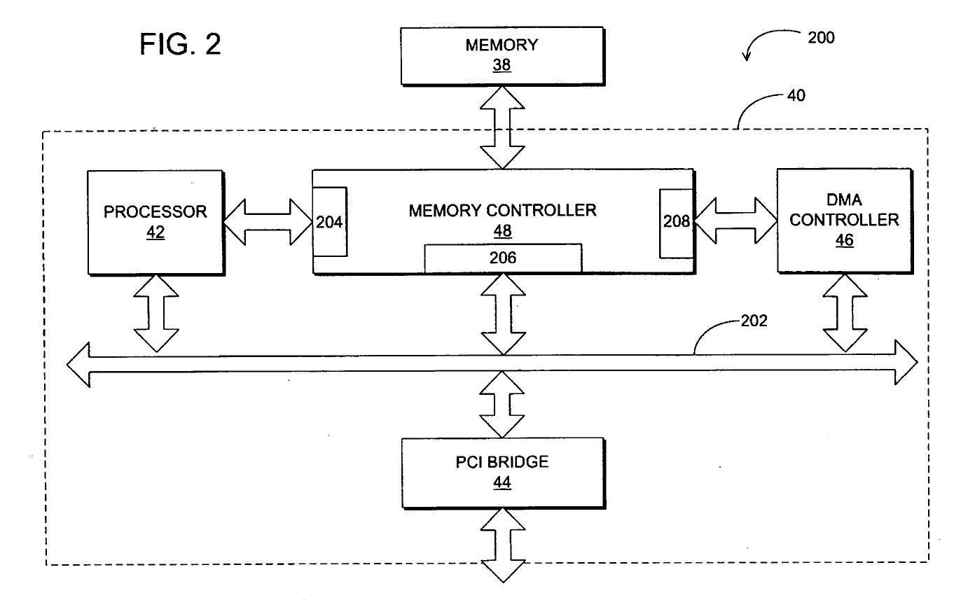

FIG. 2 is diagram 200 illustrating in more detail an integrated circuit 40 of the embodiment of FIG. 1. In FIG. 2, certain portions of the system 100 depicted in FIG. 1 have been omitted for clarity (for example circuit board 32, circuit card 20 and mass storage 50), but it is to be understood that like parts of FIG. 2 can be implemented in a manner consistent with an embodiment depicted in FIG. 1, or alternatively in other system implementations, without departing from this embodiment. For example, integrated circuit 40 depicted in FIG. 2 may comprise an integrated system on chip (SoC) which may comprise elements referred to in FIG. 1, and/or other and/or additional elements, for example, as may be used in other system embodiments.

Memory controller 48 may comprise one or more ports 204, 206 and/or 208 (and thus, memory controller 48 may be referred to as a “multi-ported memory controller 48”). Ports 204, 206 and 208 may be capable of transmitting and/or receiving commands and/or data, respectively, from one or more functional blocks external to memory controller 48. “Functional block”, as used in any embodiment herein, may be defined as circuitry that is capable of at least one of transmitting or receiving a memory read and/or write request. In the embodiment depicted in FIG. 2, exemplary functional blocks may include processor 42, PCI Bridge circuitry 44, and/or DMA controller circuitry 46, i.e., functional blocks external to memory controller 48. Of course, other and/or additional functional blocks may be used without departing from this embodiment. Further, “external to” with respect to memory controller 48 may include circuitry comprised in, or external to, integrated circuit 40.

Memory control circuitry 48 and/or DMA controller circuitry 46 and/or processor 42 and/or PCI bridge circuitry 44 may be coupled to bus 202. Bus 202 may permit, for example, memory control circuitry 48 and/or DMA controller circuitry 46 and/or processor 42 and/or PCI bridge circuitry 44 to exchange commands and/or data with each other.

Memory controller circuitry 48 may be capable of selecting a port, among a plurality of ports 204, 206 and/or 208. Memory controller circuitry 48 may also be capable of selecting between a memory read request and a memory write request from at least one port, among the plurality of ports 204, 206 and/or 208, based on, at least in part, at least one memory access rule. As used herein, “read request” and “write request” may be defined as a transaction which may be generated by a functional block external to memory controller 48, via one or more ports 204, 206 and/or 208, to read data from memory 38 or write data into memory 38, respectively. A “rule”, as used in any embodiment herein, may comprise one or more instructions. A “memory access rule”, as used in any embodiment herein, may comprise one or more instructions defining which request, among one or more memory read requests and one or more memory write requests, is to be processed by memory controller circuitry 48 to permit a functional block to read or write data in memory 38.

One exemplary memory access rule may include one or more instructions, as may be executed by memory controller circuitry 48, defining an order between memory read requests and memory write requests for at least one port 204, 206 and/or 208. Another exemplary memory access rule may include one or more instructions that memory read requests from any port are processed before matching memory write requests which may be pending in any port. Another exemplary memory access rule may include one or more instructions that define if a processor port is selected, then processor memory write requests may be given precedent over matching memory read requests in one or more ports 204, 206, and/or 208. The term “matching” or “match”, as used in any embodiment herein, is to be defined broadly as covering identical read and write requests and/or identical portions of read and write requests. For example, a read and/or write request may include one or more memory addresses, and a match may be based on identical memory addresses and/or based on a range of memory addresses.

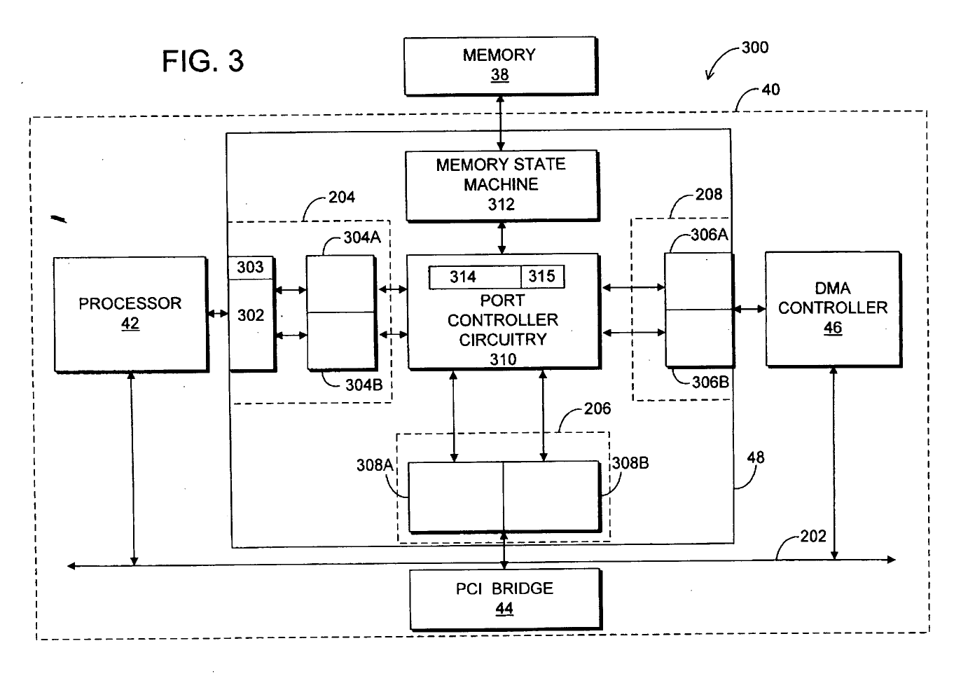

FIG. 3 is a diagram 300 illustrating in more detail exemplary memory control circuitry 48 of an integrated circuit 40 of the embodiment of FIG. 1. Processor 42, DMA controller circuitry 46 and bridge circuitry 44 may be capable of generating one or more read and/or write requests to memory controller 48. In response thereto memory controller 48 may be capable of determining which read and/or write request from among a plurality of read and/or write requests to process to permit one or more functional blocks to access memory 38.

In one embodiment, memory controller 48 may include a plurality of ports, for example, 204, 206 and/or 208 and port controller circuitry 310. Port 204 may be designated as a processor port to exchange commands and data between memory controller 48 and processor 42. Port 204 may include a read queue 304A and a write queue 304B. Read queue 304A may be capable of storing one or more pending read requests for data stored in memory 38, as may be generated by processor 42. Read queue 304A may be capable of storing pending read request by storing address locations and/or address ranges of desired data to be read from memory 38. Write queue 304B may be capable of storing one or more pending write requests to write data into memory 38, as may be generated by processor 42. Write queue 304B may be capable of storing pending write request by storing address locations and/or address ranges of write locations in memory 38 corresponding to one or more data write requests. Write queue 304B may also be capable of storing data to be written into memory 38 corresponding to one or more data write requests.

Port 206 may be designated as a port to exchange commands and data between memory controller 48 and PCI bridge circuitry 44. Port 206 may include a read queue 308A and a write queue 308B, which may operate in a manner similar to read queue 304A and write queue 304B, respectively, except for 308A and 308B may queue memory read and write requests for PCI bridge circuitry 44. Likewise, port 208 may be designated as a port to exchange commands and data between memory controller 48 and DMA controller circuitry 46. Port 208 may include a read queue 306A and a write queue 306B, which may operate in a manner similar to read queue 304A and write queue 304B, respectively, except that 306A and 306B may queue memory read and write requests for DMA controller circuitry 46.

Memory controller 48 may also include memory state machine circuitry 312 which may be capable of providing interface signals between memory controller 48 and memory 38. Such interface signals, as may be generated by memory state machine circuitry 312, may be defined by the type of memory 38 available. Exemplary memory types may include Synchronous Dynamic Random Access Memory (SDRAM), Flash RAM, Double Data Rate SDRAM (DDR SDRAM), Static Random Access Memory (SRAM), and/or Quad Data Rate SRAM (QDR SRAM) and/or other types of memory. Of course, after-developed memory types may also be used, and may be considered equivalent to the description provided herein.

As stated above, memory controller circuitry 48 may include port controller circuitry 310 which may be capable of controlling read and write access to memory 38 from a plurality of ports, based on one or more access rules. Port controller circuitry 310 may be capable of selecting which port, among a plurality of ports, is given priority to read data from memory 38 or write data to memory 38. Selection of a port, among a plurality of ports, may be based on assigned and/or programmable port priority levels. For example, port controller circuitry 310 may give port 204 priority over either ports 206 and 208, since port 204 may receive read and/or write requests from processor 42. Of course, this priority is only an example, and other priority may given to other functional blocks depicted in FIG. 3 (or other functional blocks not shown) without departing from this embodiment. Port controller circuitry 310 may also be capable of assigning an order for memory read and/or write request from one or more ports 204, 206 and/or 208.

To that end, port controller circuitry 310 may include rules engine circuitry 314 and address comparator circuitry 315. Rules engine circuitry 314 may include one or more memory access rules, and may be capable of defining an order to memory read requests and/or memory write request for one or more ports 204, 206, 208 comprised in memory controller 48.

Exemplary rules which may be defined by rules engine circuitry 314 may include, for example, that memory read requests as may be stored in one or more read queues 304A, 306A and/or 308A may be processed by port controller circuitry 310 in the order in which such pending read requests are stored in a respective read queue. “Process” or “processing”, as used in any embodiment herein in reference to memory controller circuitry 48, may be defined as accessing memory 38 to read data from memory 38 and/or transmitting data to a port and/or write data to memory 38 from a selected port, in accordance with a memory read request or memory write request, respectively. Thus, for example, read requests stored in any or all queues may be processed by port controller circuitry 310 on a first-in-first-out (FIFO) basis. Likewise, memory write requests, as may be stored in one or more write queues 304B, 306B and/or 308B, may be processed by port controller circuitry 310 on a FIFO basis.

Another exemplary rule which may be defined by rules engine circuitry 314 may include, for example, that if a read request is selected for any port, among a plurality of ports, a match may be determined between the selected read request address and one or more pending write request addresses in any port. To that end, address comparator circuitry 315 may be capable of comparing, on an address basis, selected read requests for a selected port against one or more pending write requests (as may be stored in one or more write queues) in any or all ports. If an address match is found, rules engine circuitry 314 may include an instruction to instruct port controller circuitry 310 to process the pending write request (or write requests, if more than one such request matching the read address is present in one or more ports). Address comparator circuitry 315 may be capable of performing an exact address comparison between one or more read address (stored in one or more read queues) and one or more write requests (stored in one or more write queues). Alternatively or additionally, address comparator circuitry 315 may be capable of performing a comparison of a read address against a range of addresses of write requests. Thus, the granularity of the compare operation may be selected based on, for example, speed verses accuracy considerations, and/or other considerations which may be relevant to a given operating environment.

Port 204 may include preport controller circuitry 302, and address comparator circuitry 303. Preport controller circuitry 302 may be capable of executing one or more rules which may be specific to new memory write requests from processor 42. Preport controller circuitry 302 may include a rule that pending read requests stored in read queue 304A are processed before new write requests from processor 42. Thus, preport controller circuitry 302 may be capable of determining if a new write request, generated by processor 42, matches one or more pending read requests stored in read queue 304A. In one embodiment, preport controller circuitry 302 may be capable of ensuring that if a new write request matches a pending read request in read queue 304A, the pending read request may be processed, for example by port controller circuitry 310 as described above, before new data is written into memory 38 from the new write request.

To that end, address comparator circuitry 303 may be capable of comparing one or more read request addresses stored in read queue 304A to one or more new write requests generated by processor 42. If a match is found, preport controller circuitry 302 may wait for the pending read requests stored in queue 304A to complete before storing the new write request into the processor port write queue 304B. Address comparator circuitry 303 may be capable of performing an exact address comparison between addresses stored read queue 304A and an address of a write request (as may be issued by processor 42). Alternatively or additionally, address comparator circuitry 303 may be capable of performing a comparison of a range of addresses stored read queue 304A an address of a write request (as may be issued by processor 42). Thus, the granularity of an address compare operation as may be performed by address comparator circuitry 303 may be selected based on, for example, speed verses accuracy considerations, and/or other considerations which may be relevant to a given operating environment.

A plurality of pending read requests may be stored in any given read queue (304A, 306A, 308A), and a plurality of write requests may be stored in any given write queue (304B, 306B, 308B). As mentioned above, read and write requests may be processed on a FIFO basis. Referring to a comparison operation (described above), a match between a pending read and a new write request may not necessarily exist between the first read requests, but rather, with a read request further down in the pending queue. In this case, one or more read requests that precede a read request that matches a pending write request may be processed first, i.e., before the pending write request.

Although preport controller 302 and comparator 303 are depicted graphically as separate from port controller circuitry, it is equally contemplated in this embodiment that the functions described herein as being associated with preport controller 302 and comparator 303 may be comprised within port controller circuitry 310 and/or elsewhere in memory controller circuitry 48.

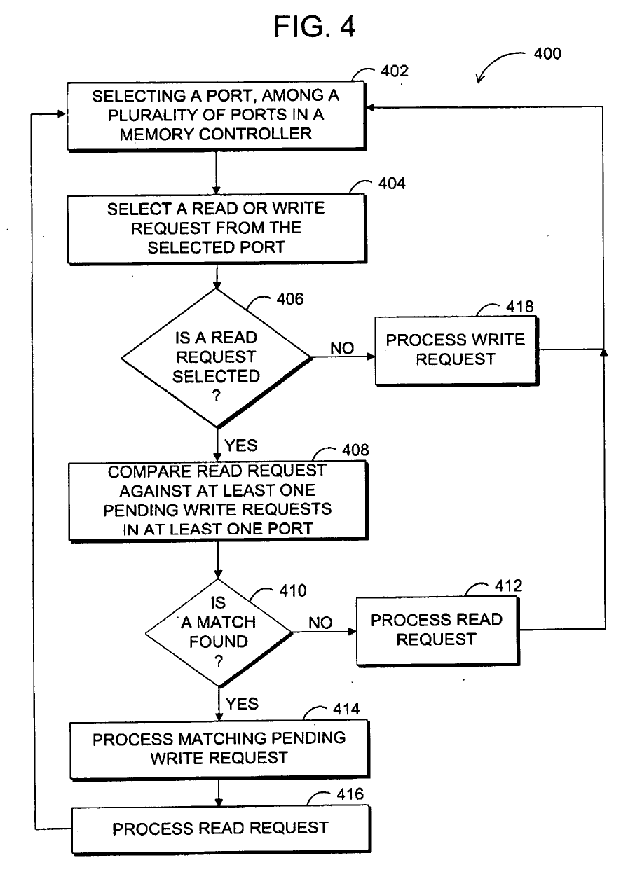

FIG. 4 is a flowchart 400 of exemplary operations according to an embodiment. Operations may include selecting a port, among a plurality of ports, in a memory controller 402. Operations may also include selecting a read request or a write request from the selected port 404. If a write request is selected 406, operations may include processing the write request 418. Operations may also include returning to operations 402. If a read request is selected 406, operations may also include comparing the read request against one or more pending write requests 408. Operation 408 may be performed on a port-by-port basis, or may be performed globally for all ports in the memory controller. If a match is found 410 (between the read request and one or more pending write requests), operations may also include processing the matching pending write request 414, then processing the read request 416. Of course, if more than one matching pending write request is found, operations may also include processing more than one pending write request. In one embodiment, processing the matching pending write request 414 may be performed in a FIFO manner as described herein. Operations may also include returning to operations 402. If a match is not found 410, operations may include processing the read request 412. Of course, operations may also include returning to operations 402.

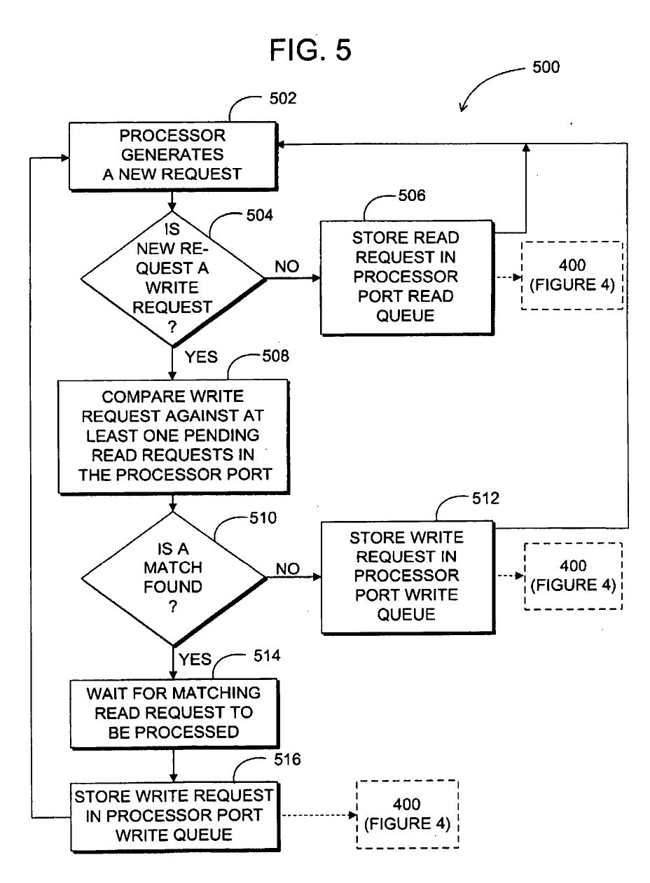

FIG. 5 is a flowchart 500 of exemplary operations according to an embodiment. Operations may include determining that a processor has generated a new request 502. Operations may also include determining if the new request is a write request 504, and if not (i.e., the new request is a read request), operations may also include storing the new read request in the processor port read queue 506. Operations may further include performing one or more operations of the flowchart 400 of FIG. 4. If the new request is a write request 504, operations may include comparing the new write request against at least one pending read request in the processor port read queue 508. If a match is found 510 (between the new write request against at least one pending read request), operations may include waiting for the matching read request to be processed 514, and then storing the new write request in the processor port write queue 516. Operations may further include performing one or more operations of the flowchart 400 of FIG. 4. If a match is not found 510, operations may include storing the new write request in the processor port write queue 512. Of course, operations may also include performing one or more operations of the flowchart 400 of FIG. 4.

Thus, in summary, an integrated circuit embodiment provided herein may include memory controller circuitry. The memory controller circuitry may include a plurality of ports, and the memory controller circuitry may be capable of selecting a port, among a plurality of ports. The memory controller circuitry may further be capable of selecting between a memory read request and a memory write request from at least one port, among the plurality of ports, based on, at least in part, at least one memory access rule.

A system embodiment provided herein may include a circuit card including an integrated circuit. The circuit card may be coupled to a bus. The integrated circuit may include memory controller circuitry. The memory controller circuitry may include a plurality of ports. The memory controller circuitry may be capable of selecting a port, among the plurality of ports. The memory controller circuitry may be further capable of selecting between a memory read request and a memory write request from at least one port, among the plurality of ports, based on, at least in part, at least one memory access rule.

The integrated circuit of one or more of these embodiments may offer enhanced data access coherency and structured ordered of memory access operations. Additionally, in at least one embodiment described herein, memory controller circuitry 48 may be capable of ensuring that the latest (i.e., freshest) data is available in memory 38 for pending or future reads of that data. As an example, and referring again to FIG. 3, processor 42 may be capable of generating a core descriptor which may define writing data to memory 38 and transferring the written data stored in memory 38 from one location to another. Upon issuing a core descriptor, processor 42 may exchange a command with DMA controller (via bus 202) to read the new data in memory 38 and transfer the new data to a designated location. A data write request may be issued by processor 42 to processor port 204 and stored in write queue 304B. Similarly, a data read request, identifying the data to be written by the write request issued by processor 42, may be issued by DMA controller circuitry 46 to port 208 and stored in read queue 306A. At least one memory access rule as described herein may provide that a data write from processor 42 is given precedence over data reads matching the address (or addresses) of the data write from one or more ports.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Indeed, without departing from this embodiment, system 100 may include more or fewer than the elements shown in the Figures and described previously herein as being comprised system 100. Other modifications, variations, and alternatives are also possible. Accordingly, the claims are intended to cover all such equivalents.

What is claimed is:

1. A method, comprising:
selecting a port, among a plurality of ports;
selecting between a memory read request and a memory write request from at least one port, among said plurality of ports, based on, at least in part, at least one memory access rule.

2. The method of claim 1, wherein:
said at least one memory access rule comprising:
determining if said memory read request is selected;
comparing said memory read request and at least one pending memory write request from at least one port among said plurality of ports; and
processing said pending memory write request if a match exists between said memory read request and said pending memory write request.

3. The method of claim 2, wherein:
said at least one memory access rule further comprising:
processing said memory read request if a match does not exist between said memory read request and said at least one pending write request.

4. The method of claim 2, wherein:
said at least one memory access rule further comprising:
processing said memory read request after said processing of said at least one pending memory write request.

5. The method of claim 1, wherein:
said at least one memory access rule comprising:
determining that a processor has generated a new write request to a processor port;
comparing said new write request against at least one pending read request in said processor port;
waiting for at least one pending read request to be processed if a match exists between said new write request against at least one pending read request; and
storing said new write request in said processor port.

6. The method of claim 5, wherein:
said at least one memory access rule further comprising:
storing said new write request in said processor port if a match does not exist between said new write request and said at least one pending read request in said processor port.

7. The method of claim 5, wherein:
said at least one memory access rule further comprising:
processing said memory write request from said processor port after processing of said at least one pending memory read request.

8. The method of claim 1, wherein:
said at least one memory access rule comprising:
processing said memory write request before processing said memory read request if a match exists between said memory write request and said memory read request.

9. The method of claim 1, wherein:
said at least one memory access rule comprising:
processing at least one said read request in a processor port before processing a new write request in said processor port.

10. An apparatus, comprising:
an integrated circuit comprising memory controller circuitry, said memory controller circuitry comprising a plurality of ports, said memory controller circuitry capable of selecting a port, among said plurality of ports, said memory controller circuitry is further capable of selecting between at least memory read request and at least one memory write request from at least one port, among said plurality of ports, based on, at least in part, at least one memory access rule.

11. The apparatus of claim 10, wherein:
said memory controller circuitry further comprising comparator circuitry and said at least one memory access rule comprising:
determining, by said memory controller circuitry, if said memory read request is selected;
comparing, by said comparator circuitry, said memory read request and at least one pending memory write request from at least one port among said plurality of ports; and
processing, by said memory controller circuitry, said pending memory write request if a match exists between said memory read request and said pending memory write request.

12. The apparatus of claim 11, wherein:
said at least one memory access rule further comprising:
processing, by said memory controller circuitry, said memory read request if a match does not exist between said memory read request and said at least one pending write request.

13. The apparatus of claim 11, wherein:
said at least one memory access rule further comprising:
processing, by said memory controller circuitry, said memory read request after said processing of said at least one pending memory write request.

14. The apparatus of claim 10, wherein:
said integrated circuit further comprising processor circuitry capable or generating at least one new memory write request, said memory controller circuitry further comprising a processor port coupled to said processor circuitry and comparator circuitry and said at least one memory access rule comprising:
determining, by said processor port, that a processor has generated a new write request to said processor port;
comparing, by said comparator circuitry, said new write request against at least one read request in said processor port;
waiting for at least one pending read request to be processed if a match exists between said new write request against at least one pending read request; and
storing said new write request in said processor port.

15. The apparatus of claim 14, wherein:
said at least one memory access rule further comprising:
storing said new write request in said processor port if a match does not exist between said new write request and said at least one pending read request in said processor port.

16. The apparatus of claim 14, wherein:
said at least one memory access rule further comprising:
processing said memory write request from said processor port after processing of said at least one pending memory read request.

17. The apparatus of claim 10, wherein:
said at least one memory access rule comprising:
processing, by said memory controller circuitry, said memory write request before processing said memory read request if a match exists between said memory write request and said memory read request.

18. The apparatus of claim 10, wherein:
said at least one memory access rule comprising:
processing at least one said read request in a processor port before processing a new write request in said processor port.

19. A system, comprising:
a circuit card including an integrated circuit, the circuit card being capable of being coupled to a bus, the integrated circuit comprising memory controller circuitry, said memory controller circuitry comprising a plurality of ports, said memory controller circuitry capable of selecting a port, among said plurality of ports, said memory controller circuitry is further capable of selecting between a memory read request and a memory write request from at least one port, among said plurality of ports, based on, at least in part, at least one memory access rule.

20. The system of claim 19, wherein:
said memory controller circuitry further comprising comparator circuitry and said at least one memory access rule comprising:
determining, by said memory controller circuitry, if said memory read request is selected;
comparing, by said comparator circuitry, said memory read request and at least one pending memory write request from at least one port among said plurality of ports; and
processing, by said memory controller circuitry, said pending memory write request if a match exists between said memory read request and said pending memory write request.

21. The system of claim 20, wherein:
said at least one memory access rule further comprising:
processing, by said memory controller circuitry, said memory read request if a match does not exist between said memory read request and said at least one pending write request.

22. The system of claim 20, wherein:
said at least one memory access rule further comprising:
processing, by said memory controller circuitry, said memory read request after said processing of said at least one pending memory write request.

23. The system of claim 19, wherein:
said integrated circuit further comprising processor circuitry capable or generating at least one new memory write request, said memory controller circuitry further comprising a processor port coupled to said processor circuitry and comparator circuitry and said at least one memory access rule comprising:
determining, by said processor port, that a processor has generated a new write request to said processor port;
comparing, by said comparator circuitry, said new write request against at least one read request in said processor port;
waiting for at least one pending read request to be processed if a match exists between said new write request against at least one pending read request; and
storing said new write request in said processor port.

24. The system of claim 23, wherein:
said at least one memory access rule further comprising:
storing said new write request in said processor port if a match does not exist between said new write request and said at least one pending read request in said processor port.

25. The system of claim 23, wherein:
said at least one memory access rule further comprising:
processing said memory write request from said processor port after processing of said at least one pending memory read request.

26. The system of claim 19, wherein:
said at least one memory access rule comprising:
processing, by said memory controller circuitry, said memory write request before processing said memory read request if a match exists between said memory write request and said memory read request.

27. The system of claim 19, wherein:
said at least one memory access rule comprising:
processing at least one said read request in a processor port before processing a new write request in said processor port.

28. An article, comprising:
a storage medium having stored thereon instructions that when executed by a machine result in the following operations:
selecting a port, among a plurality of ports; and
selecting between a memory read request and a memory write request from at least one port, among said plurality of ports, based on, at least in part, at least one memory access rule.

29. The article of claim 28, wherein:
said at least one memory access rule comprising:
determining if said memory read request is selected;
comparing said memory read request and at least one pending memory write request from at least one port among said plurality of ports; and
processing said pending memory write request if a match exists between said memory read request and said pending memory write request.

30. The article of claim 29, wherein:
said at least one memory access rule further comprising:
processing said memory read request if a match does not exist between said memory read request and said at least one pending write request.

31. The article of claim 29, wherein:
said at least one memory access rule further comprising:
processing said memory read request after said processing of said at least one pending memory write request.

32. The article of claim 28, wherein:
said at least one memory access rule comprising:
determining that a processor has generated a new write request to a processor port;
comparing said new write request against at least one pending read request in said processor port;
waiting for at least one pending read request to be processed if a match exists between said new write request against at least one pending read request; and
storing said new write request in said processor port.

33. The article of claim 32, wherein:
said at least one memory access rule further comprising:
storing said new write request in said processor port if a match does not exist between said new write request and said at least one pending read request in said processor port.

34. The article of claim 32, wherein:
said at least one memory access rule further comprising:
processing said memory write request from said processor port after processing of said at least one pending memory read request.

35. The article of claim 28, wherein:
said at least one memory access rule comprising:
processing said memory write request before processing said memory read request if a match exists between said memory write request and said memory read request.

36. The article of claim 28, wherein:
said at least one memory access rule comprising:
processing at least one said read request in a processor port before processing a new write request in said processor port.
